(19) United States
(12) Patent Application Publication
(10) Pub. No.: US 2019/0345735 A1
(43) Pub. Date: Nov. 14, 2019

(54) KEY STORAGE SYSTEM, KEY ATTACHMENT AND KEY BOX

(71) Applicant: Artin Melikian, Montrose, CA (US)

(72) Inventor: Artin Melikian, Montrose, CA (US)

(21) Appl. No.: 16/351,281

(22) Filed: Mar. 12, 2019

Related U.S. Application Data
(60) Provisional application No. 62/643,110, filed on Mar. 14, 2018.

(51) Int. Cl. E05B 19/00; A47G 29/10

(52) U.S. Cl. CPC E05B 19/00; A47G 29/10

(57) ABSTRACT

A two-piece key attachment includes a key holder. The key holder includes a first edge opening on an insertion side; a second edge opening on a connection side; an interior opening, the interior opening formed by two or more interior walls; and one or more connectors, wherein the key holder is configured to a key inserted through the first edge opening and have a portion of the key exiting the connection side. The two-piece key attachment includes a key connector. The key connector includes a first edge opening on a connection side, the first edge opening configured to receive the portion of the key that exits the connection side of the key holder; and one or more opposing connectors to attach to the one or more connectors on the key holder.

### RELATED APPLICATIONS

This application claims priority to U.S. provisional patent application Ser. No. 62/643,110, filed Mar. 14, 2018, entitled Key Storage System and Key Box, the disclosure of which is hereby incorporated by reference.

### BACKGROUND OF THE INVENTION

Attachments for storing single keys (e.g., for a valet or an apartment manager) are very cumbersome and not easy to use. They are not easily-labeled and it is difficult to remember which key belongs to which guest or resident. In many cases, the key attachments do not hold different size keys and thus keys may be lost. In addition, boxes for storing keys are not designed to have multiple key attachments and in many cases, the keys have to be wrapped around a piece of wire and there is not an easy way to manage all of the keys that are located in the key box. In addition, key holders do not have space to write identifying descriptions and are not easy to navigate. There are also not many opportunities to store key attachments.

### BRIEF DESCRIPTION OF THE DRAWINGS

FIG. 1A illustrates a front view of a key holder according to embodiments;

FIG. 1B illustrates a back view of a key holder according to embodiments;

FIG. 1C illustrates a top cut away view according to embodiments;

FIG. 1D illustrates a front view of a key holder in an alternative embodiment;

FIG. 1E illustrates a top cut-away of a key holder in an alternative embodiments;

FIG. 1F illustrates a key connector and a key holder according to embodiments;

FIG. 1G illustrates a key connector and a key holder according to embodiments;

FIG. 1H illustrates labels on a key connector and on a key connector according to embodiments;

FIG. 1I illustrates a different shaped key holder according to embodiments;

FIG. 1J illustrates a different shaped opening in a key holder according to embodiments;

FIG. 1K illustrates another shape (e.g., a semi-circular shape at a top of a key holder) for the key holder according to embodiments;

FIG. 1L illustrates a key holder with a grip tab according to embodiments;

FIG. 1M illustrates a key holder and a key connector including a pull tab according to embodiments;

FIG. 2A illustrates a back view of a key connector according to embodiments;

FIG. 2B illustrates a front view of a key connector according to embodiments;

FIG. 2C illustrates a top cut-away view according to embodiments;

FIG. 3 illustrates a use of a shim in a key holder;

FIG. 4 illustrates a use of velcro strips of material on a key and an interior surface of a key holder according to embodiments;

FIG. 5A illustrates a key being held in place by a pin according to embodiments;

FIG. 5B illustrates another embodiment where a pin holds a key in place in a key holder;

FIG. 6 illustrates use of a screw and screw hole to hold a key in a key holder according to embodiments;

FIG. 7 illustrates a key holder being connected to a key holder being connected to a key connector via one or more channels and one or more grooves according to embodiments

FIG. 8 illustrates a key holder being connected to a key connector via magnets according to embodiments;

FIG. 9 illustrates a key holder being connected or attached to a key connector by a clip or clasp according to embodiments;

FIG. 10A illustrates a key holder being connected or attached to a key connector by a key holder having one or more recesses or a key connector having one or more inserts according to embodiments;

FIG. 10B illustrates a key holder being connected or attached to a key connector by a key holder, the key holder having one or more tabs and the key connector having one or more recesses according to embodiments;

FIG. 11A illustrates a key itself (especially if metallic) being utilized to connect a key holder and key connector according to embodiments;

FIG. 11B illustrates a front view of a key holder according to embodiments;

FIG. 11C illustrates a front view of a key connector according to embodiments;

FIG. 12A illustrates a key sheet having a plurality of key attachments according to embodiments;

FIG. 12B illustrates a clear plastic sheet that holds a plurality of key attachments according to embodiments; and

FIG. 13 attempts to illustrate three rings and a spine being inserted into a valet key box or key box;

### DETAILED DESCRIPTION

The foregoing, and other features and advantages of the invention, will be apparent from the following, more particular description of the preferred embodiments of the invention, the accompanying drawings, and the claims.

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

The presently claimed subject matter leads to a key attachment for containing keys that provides more space (via labels to write descriptions). In some embodiments, this makes the key attachment easier to navigate and find additional keys. In addition, the different embodiments provide a stronger grip on the key holder. In addition, the key attachments are easier to store because the key is not visible and is protected. There are no jagged edges and the key attachment is a uniform size so that sheets of plastic may hold a specific number in notebooks and/or three-ring binders. In addition, the sheets of plastics may be placed or integrated into hanging folders, which then can be stored in file folders and/or can be stored in file cabinets.

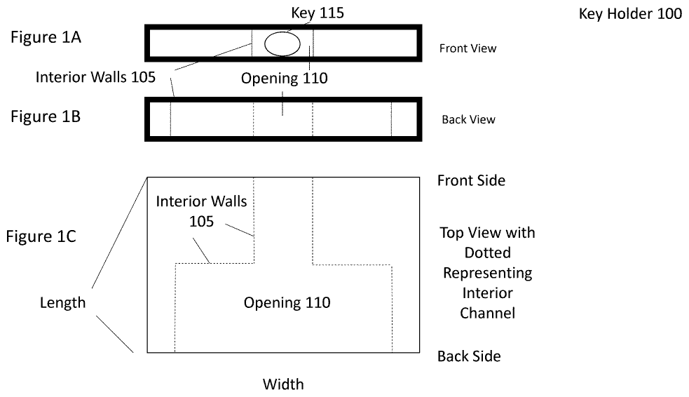

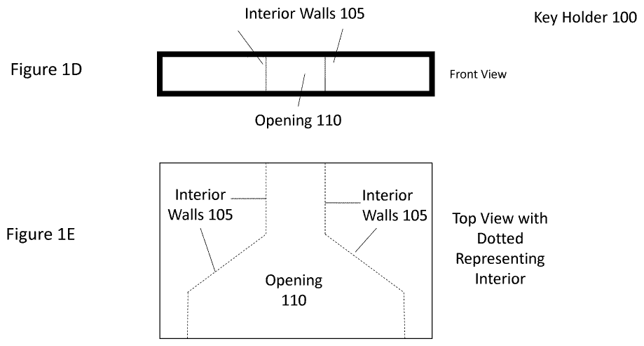

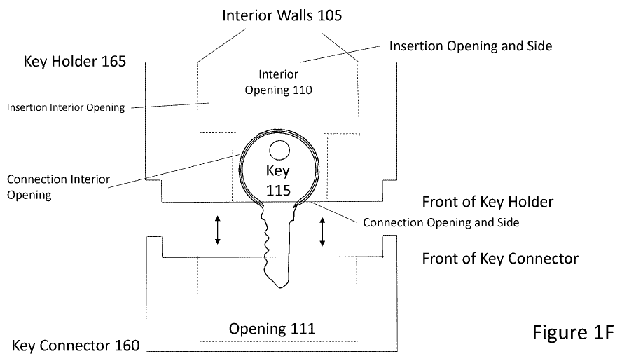

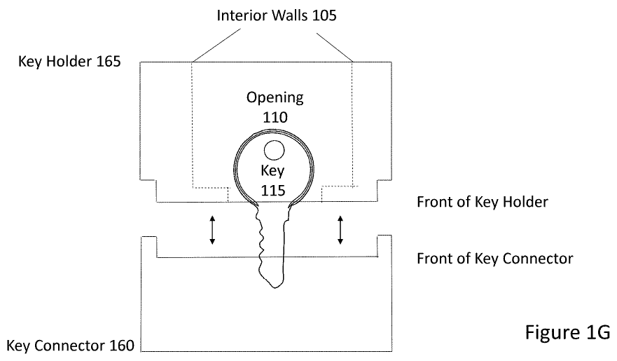

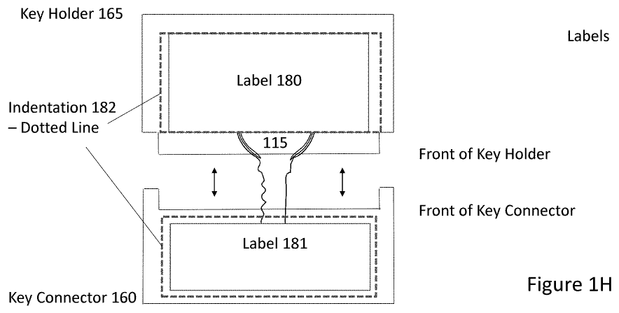

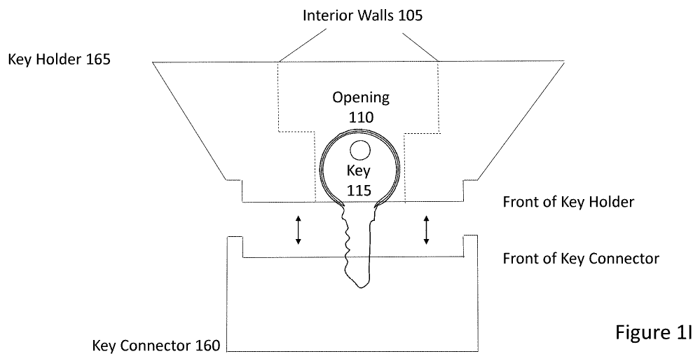

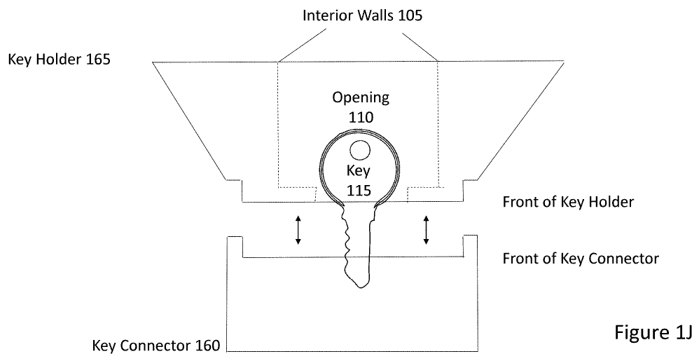

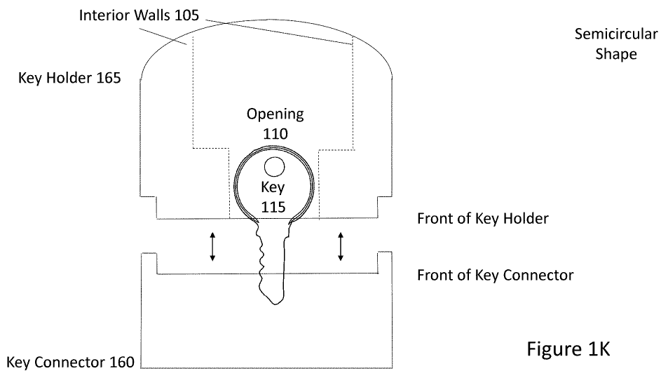

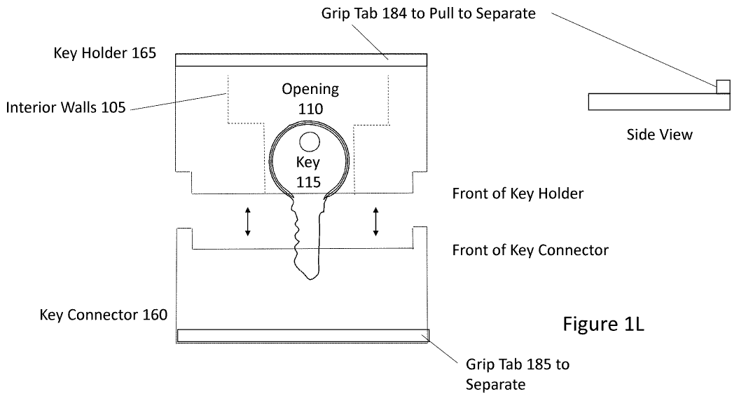

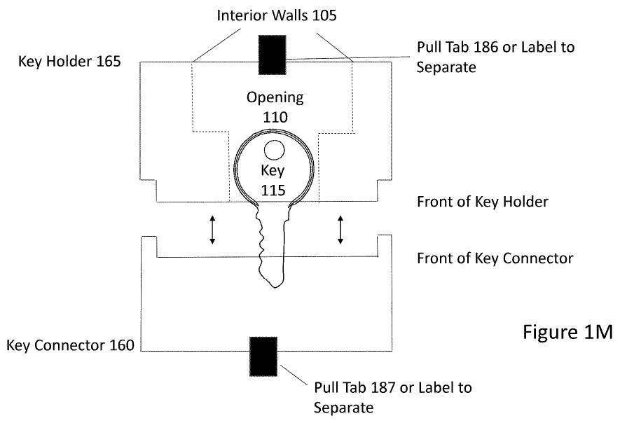

FIG. 1F illustrates a key attachment according to embodiments. In embodiments, a key attachment may comprise a key holder 165 and a key connector 160. FIG. 1F illustrates one embodiment of a key attachment and many other embodiments are possible. Different shapes may be utilized. Different configurations of interior walls and openings may be utilized. In embodiments, a key attachment (and thus key holder 165 and key connector 160) may be made of a plastic, a wood material, a laminate, a composite material, and/or a metal. In some embodiments, one side of a key holder 165 may be referred to as an insertion side and an opposing side may be referred to as a connection opening and side In some embodiments, a key connector 160 may have a connection opening or an opposing connection opening or side to the key holder connection opening or side.

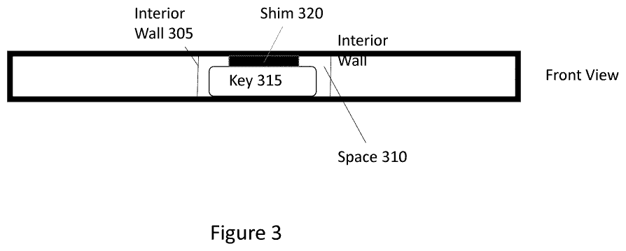

In embodiments, a key attachment may comprise a key holder and a key connector. In embodiments, a key holder 100 may hold the key in the key attachment system. In embodiments, a key holder may be made of a lightweight plastic. In embodiments, a key holder may be made of a composite material and/or a 3D printed material. In embodiments, a key holder may have a length, a width and a thickness or depth. FIG. 1A illustrates a front view of a key holder according to embodiments. FIG. 1B illustrates a back view of a key holder according to embodiments. FIG. 1C illustrates a top cut away view according to embodiments. In embodiments, a key holder length may be 1½ inches and may have a range of 0.5 inches to 3.0 inches. In embodiments, a key holder width may be 1¾ inches and a key holder width may have a range of 0.5 inches to 3.0 inches. In embodiments, a key holder may have a thickness that is slightly larger than a thickness of a key. In embodiments, a key holder may have a thickness of 0.02 inches to 0.6 inches. In embodiments, this may allow almost any key to be inserted into the key holder. In embodiments, a key holder 100 has an opening 110 on a side. In embodiments, the key may be inserted through the opening and be positioned or reside in a channel that is formed by interior walls 105. In embodiments, an opening at a front of a key holder may be, for example, ⅝ths of an inch (where it is narrowed) and the opening at the back of the key holder may be 1½ inch (where it is wider). In embodiments, interior walls 105 may be formed or made of a plastic. In embodiments, interior walls 105 may have a small width or may have a width all the way to the edge of the key holder to prevent a user from placing a key in a wrong opening. In embodiments, an opening 110 may have a smaller width at a front of a key holder because the front of the key holder 100 may be connected or attached to a key connector and a key may need to be held in place. A positioning of a key in an opening is shown in FIG. 3. In embodiments, a key is inserted into a key holder 100 through a back of a key holder 100 via the opening 110 which is wider at the back of the key holder 100. In embodiments, the key holder 100 has a thickness which is illustrated by the heavier bolded lines in FIGS. 1A and 1B. FIG. 1D illustrates a front view of a key holder in an alternative embodiment. FIG. 1E illustrates a top cut-away of a key holder in an alternative embodiment. In this alternative version, interior walls are positioned different to create the space or opening 110 in the key holder. In this alternative embodiment, as illustrated in FIGS. 1D and 1E, interior walls 105 are placed at an angle to reduce a width of the opening 110 in the key holder 100.

FIG. 1F illustrates a key connector and a key holder according to embodiments. FIG. 1G illustrates a key connector and a key holder according to embodiments. In embodiments, a length of interior walls 105 may be longer coming from a back of a key holder 165. In embodiments, a key connector 160 may comprise an opening 111, as shown in FIGS. 1F and 1G. In these embodiments, there is no need for different widths from the key is getting inserted into the key holder and held by different assemblies in the key holder 165. FIG. 1F also illustrates additional elements of a key holder. In some embodiments, an end or side where a key may be inserted may be referred to as an insertion side and the opening in the key holder may be referred to as an insertion opening. In some embodiments, an end or side where a key may pass through on the way to the key connector is a connector side or connection side or opening. In some embodiments, the opening may be referred to as the connection opening. In some embodiments, the interior opening 110 may be divided into two areas with one of the areas being smaller than the other area. In some embodiments, there is an insertion interior area that begins on the insertion side and a connection interior area that begins at the connection side. In some embodiments, the area of the insertion interior area is greater than the connection interior area because the key needs to be inserted but not fall though the key holder. The smaller interior area may be caused by either narrowing a length dimension or a width dimension of interior walls.

FIG. 1H illustrates labels on a key connector and on a key connector according to embodiments. In embodiments, label 180 may be placed on a top surface of a key holder 165. In embodiments, label 181 may be placed on a bottom surface of a key connector 160. In embodiments, labels 180 and 181 may be adhered to a top surface via a light adhesive. In embodiments, labels 180 and 181 may be printed on and may be written on by any ink pens and/or pencils. This provides an advantage over prior art systems because labels 180 and 181 can be matched in order to combine the keys easily. In embodiments, labels 180 and 181 may be easily seen because they are installed in clear plastic sheets, in a key box and/or on top of a clean paper sheet. In embodiments, as shown by the thicker line in FIG. 1H, a slight indentation 182 in a top surface of a key holder 165 and/or key connector 160 may be made in order for the labels 180 and 181 to be applied and not be higher than a surface of the key holder 165 or key connector 160. In embodiments, a slight indentation may have a thickness of 0.001 to 0.1 inches.

FIG. 1I illustrates a different shaped key holder according to embodiments. FIG. 1J illustrates a different shaped opening in a key holder according to embodiments. In embodiments, a key holder 165 may have a trapezoidal shape and in FIG. 1J, an opening 110 may have a different shape. FIG. 1K illustrates another shape (e.g., a semi-circular shape at a top of a key holder 165) for the key holder according to embodiments. This may be referred to as a semicircular shape.

In embodiments, there may be difficulty in pulling the key holder 165 and the key connector apart. FIG. 1L illustrates a key holder with a grip tab 184 according to embodiments. In embodiments, a key holder 165 may have a grip tab 184 at a back of the key holder 165 and located or installed on a top surface of the key holder 165. In embodiments, a key connector 160 may have a grip tab 185 at a back of the key connector 160 and located or installed on a top surface of the key connector 160. In embodiments, a user or operator may grab a grip tab 184 or 185 and pull to attempt to separate the key holder 165 from the key connector 160. In embodiments, the grip tab 184 or 185 may rise a certain height dimension from a top surface of the key holder 165 or key connector 160 to allow a user or operator to get a better grip in order to pull apart the key connector 160 and the key holder 165. FIG. 1M illustrates a key holder and a key connector including a pull tab according to embodiments. In embodiments, a key holder 165 may comprise a pull tab 186 installed on a top surface of the key holder 165. In embodiments, a key connector 160 may comprise a pull tab 187 installed on a top surface of the key connector 160. In embodiments, either of the pull tabs 186 or 187 may be grabbed or pulled in order to separate a key holder 165 from a key connector 160. In embodiments, a pull tab 186 or 187 may be adhered to a top surface of a key holder 165 or a key connector 160. In embodiments, a grip tab 184 and/or a pull tab 186 may be installed on a bottom surface of a key holder 165. In embodiments, a grip tab 185 and/or a pull tab 187 may be installed on a bottom surface of a key connector 160.

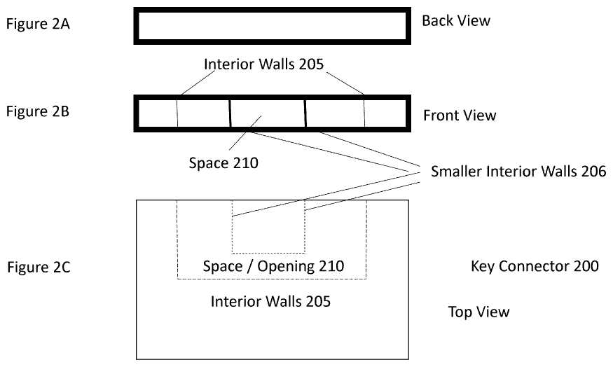

FIG. 2A illustrates a back view of a key connector according to embodiments. FIG. 2B illustrates a front view of a key connector 200 according to embodiments. FIG. 2C illustrates a top cut-away view according to embodiments. FIGS. 2A, 2B and 2C illustrate two embodiments of a key connector 200. In a first embodiment, a space or opening 210 to which a key and/or key holder is inserted is larger. This is illustrated by the interior walls 205 in FIGS. 2B and 2C. In a second embodiments, a space or opening 210 is much smaller, which is illustrated by interior walls 206. As is illustrated in FIG. 2A, a back of a key connector 200 may be not have any opening.

In embodiments, if the key holder's thickness or depth is larger than the key (and the key is not held in place by the key holder), a shim may be included within the key holder in order to add to the thickness of the key and keep the key in the key enclosure. FIG. 3 illustrates a use of a shim in a key holder. In embodiments, a shim may also be included in a key connector, but it may be better to place in a key holder. In embodiments, such as illustrated in FIG. 3, a key 315 may not fill up all of a height of an opening or space 310. In order for a key not to fall out, a shim 320 may be inserted along with a key 315 into an opening or space in order to fill up the opening or space.

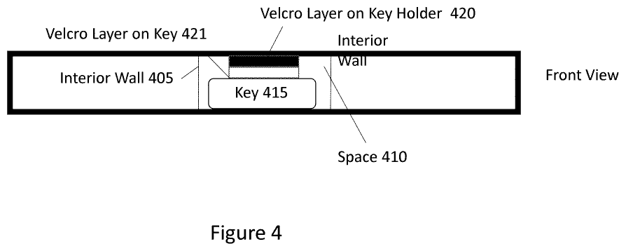

In embodiments, a key holder may have a peg on an inside surface that a hole on a key may engage. In this embodiment, the peg may hold the key in the key holder. In embodiments, a light adhesive may be coated on an inside surface of a key holder in order to secure when a key is inserted into a key holder. In embodiments, velcro may be utilized on an inside surface of the key holder. In embodiments utilizing velcro, a strip of material may be placed on an interior surface of the key holder where the strip of material has tiny hooks. In embodiments utilizing velcro, a strip of material may be placed or adhered to a key, where that strip of material may have a number of thinner loops to which the hooks may cling to when the key (with its strip of material) is inserted into a key holder (with its strip of material on an interior surface of key holder, when the two strips of material are pressed together. FIG. 4 illustrates a use of velcro strips of material on a key and an interior surface of a key holder according to embodiments. In embodiments, a velcro strip 420 may be applied or adhered an interior surface of a key holder 400. Because the key 415 height does not fill up the opening or space, velcro connectors may need to be utilized. In embodiments, a velcro strip of material 421 may be applied or adhered to a key 415. When the key is inserted into the key holder 400, the velcro strip of material 420 adhered to an inside surface of the key holder may attach or connect to the velcro strip of material adhered or applied to the key 415 in order to keep the key from slipping out of the key holder 400. The reference numbers and shapes illustrating velcro strips of materials may also illustrate adhesive layers. As mentioned above, in other embodiments, velcro strips or materials may be placed on an interior surface of a key connector.

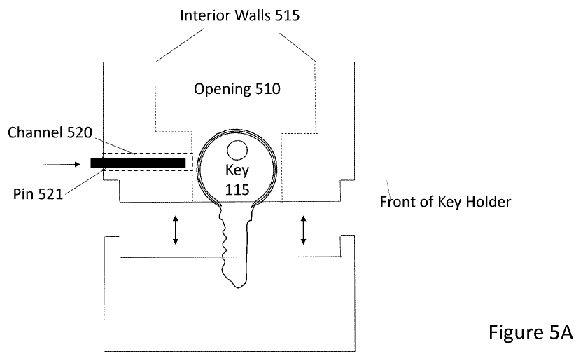

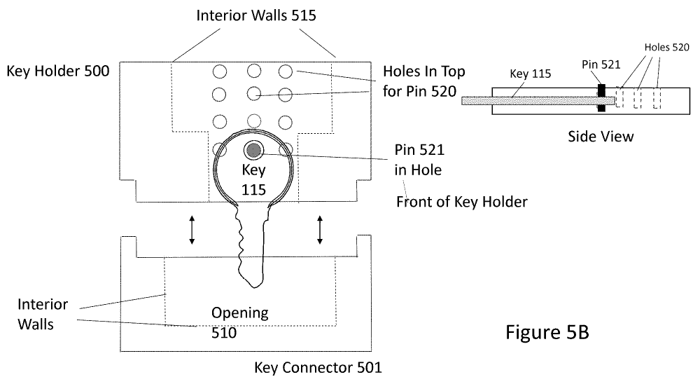

In embodiments, a key holder may include a pin to press against a key and keep the key in place in a key holder. FIG. 5A illustrates a key being held in place by a pin according to embodiments. In embodiments, a pin 521 may be placed against a key once the key 515 is inserted in to the key holder 500. In this embodiment, a pin may be inserted into and/or through a hole or channel 520 in the key holder 500 and may be adjusted or utilized by moving the pin into towards and/or through a space, hole or channel 520 in the key holder. This is illustrated by the arrow in FIG. 5A, where the pin is in resting position and may be moved towards the key 515. FIG. 5B illustrates another embodiment where a pin holds a key in place in a key holder. In the embodiment illustrated in FIG. 5B, a key holder 500 may comprise one or more holes 520 in which to place a pin 521 in order to hold a key in place in the key holder 500 and when the key 115 is inserted in the key attachment (e.g., the key holder 500 and the key connector 501). As shown in FIG. 5B, the key holder 500 may comprise a plurality of key holes 520 because the hole in a key 115 may be in different places. Thus, the plurality of key holes 520 allows almost every key (regardless of where the key hole is located) to be able to be inserted into the key holder 500 and held in place (either by the key holder 500 or the combination of the key holder 500 and the key connector 501). In embodiments, the pin 521 may pass through a hole in the key 115 and rest on an interior bottom surface of the key holder in order to hold the key in place. FIG. 5B also includes a side view of this embodiment in the upper right hand side. In embodiments, the rows of key holes may be symmetrical. FIG. 5B illustrates 4 rows of 3 holes 520 for inserting the pin.

In embodiments, an interior surface of a key holder may include a thin memory foam. In embodiments, the key may be inserted into the key holder causing depression or indentation in the memory foam. In this embodiment, the key may be held in the place by the memory foam. In embodiments, an interior surface of a key holder may have a rough surface that does not allow easy movement of the key. In this embodiment, a rough surface may be able to hold the key in the key holder because the rough surface makes it difficult for the key to be inserted. However, once it is, the key is held in place in the key holder by the rough surface.

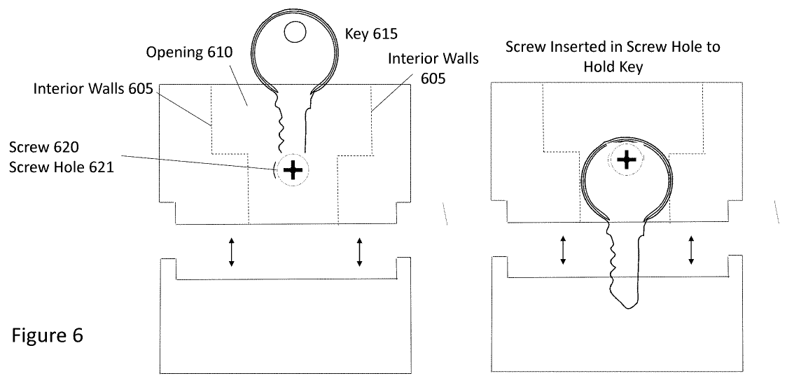

FIG. 6 illustrates use of a screw and screw hole to hold a key in a key holder according to embodiments. In embodiments, a screw hole 621 may be drilled or made into a top exterior surface (or a bottom exterior surface) of a key holder 600. Once a key 615 is inserted into a space or an opening 610 in a key holder, a hole in a key 615 (as shown in FIG. 6) may be aligned with the screw hole 621 of the key holder. In embodiments, a screw 620 may be inserted into the screw hole 621 and pass through the hole in the key 615. This may secure the key in the key holder 600. The bottom of the screw may rest against an interior surface of the key holder or may pass through an opposing hole a bottom side of a key holder. A nut and bolt combination may be utilized in another embodiment.

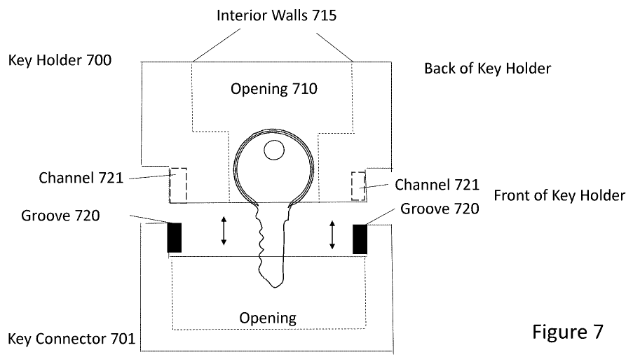

In embodiments, a key holder 700 may be connected to a key connector 701 via a number of methods, assemblies or fasteners, or other means. FIG. 7 illustrates a key holder being connected to a key holder being connected to a key connector via one or more channels and one or more grooves according to embodiments. In embodiments, a front of a key holder 700 may move towards a key connector 701. In embodiments, a key holder 700 may comprise one or more channels 721 that allow grooves to be connected to or inserted into. In embodiments, a key connector 701 may comprise one or more grooves 720. In embodiments, these grooves 720 of the key connector 701 may be inserted into or fit into a corresponding on or more channels 721 on the key holder 700 when the key holder 700 moves towards the key connector 701. When the key holder 700 and the key connector 701 are connected, they form a key storage assembly. In embodiments, a key storage assembly may be a square or a rectangular shape. In embodiments, a key storage assembly may be a number of other shapes, including an oval, a triangle or a circle, although these shapes are in no way limiting.

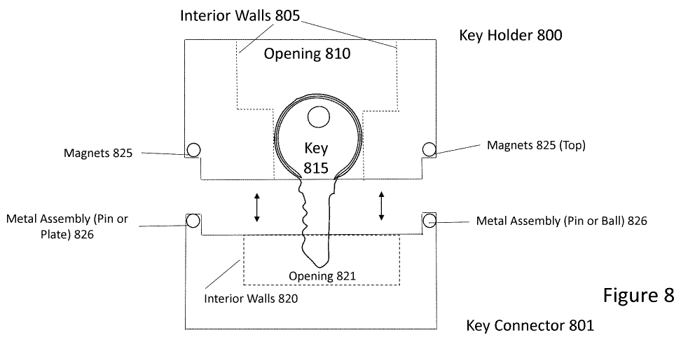

FIG. 8 illustrates a key holder being connected to a key connector via magnets according to embodiments. FIG. 8 illustrates only one placement of magnets and opposing magnets and metal assemblies may be placed at any location where a magnetic field is strong enough to be attached to a metal assembly or plate. In embodiments, a key holder 800 may comprise one or more magnets 825 being located near an edge of a key holder 800. In embodiments, a key connector 801 may comprise one or more metal assemblies 826 located near an edge of a key connector 801. In embodiments, one or more metal assemblies 826 may comprise a metal ball, a metal pin, or a metal plate or any metal that may be sufficiently attracted by the one or more magnets in the key holder 800. In embodiments, as a key holder 800 is moved towards a key connector 801, the one or more magnets 825 in the key holder 800 are attracted to the one or more metal pieces 826 in the key connector 801 and may form an attachment to the one or more metal pieces 826. In embodiments, this allows the key holder to be connected and stay connected to the key connector even when hung in a vertical manner on a key sheet which will be described later. In embodiments, the positions of the magnets 825 and the metal assemblies 826 may be reversed where the magnets are in the key connector 801 and the metal assemblies are in the key holder 800.

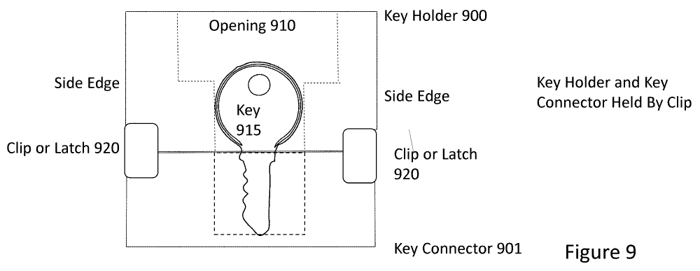

FIG. 9 illustrates a key holder being connected or attached to a key connector by a clip or clasp according to embodiments. In embodiments, a key holder 900 is attached to a key connector 901 or moved close to a key connector 901. In embodiments, one or more clips, clasps or latches 920 may be placed or attached on outside surfaces of both a key holder 900 and a key connector 901. In embodiments, the one or more clips, clasps or latches 920 may be placed on side outside surfaces of a key holder 900 and a key connector 901 in order to attach the key holder 900 and the key connector together. In embodiments, a clip, clasp or latch may be low profile so as to take up minimal space on a key sheet and allow more key attachments to be placed on a key sheet. In some embodiments, clips, clasps or latches may have a ridge that may be inserted into an opposing recess on the key connector or on both the key holder.

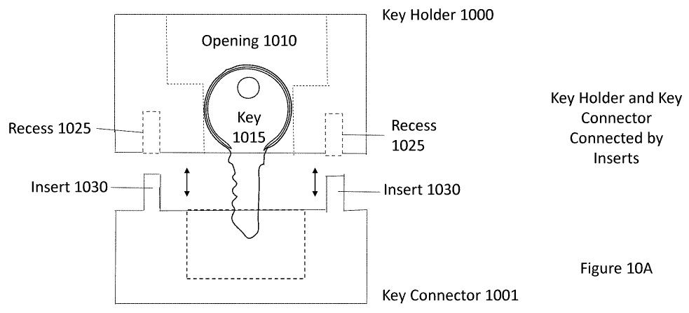

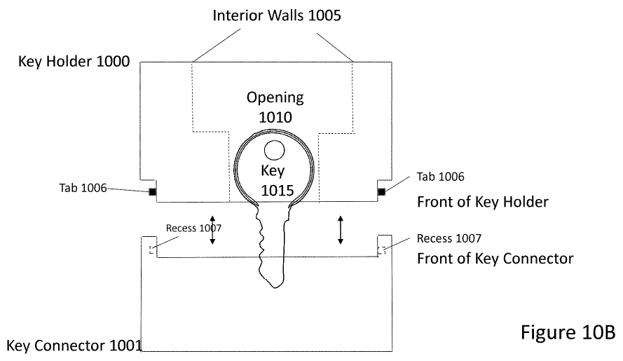

FIG. 10A illustrates a key holder being connected or attached to a key connector by a key holder having one or more recesses or a key connector having one or more inserts according to embodiments. In embodiments, a key holder 1000 may have one or more recesses 1025 located on a front side of a key holder. In embodiments, these recesses 1025 may be rectangular in shape. In embodiments, a key connector 1001 may comprise one or more inserts 1030, which may have a matching or corresponding shape to the one or more recesses 1025. In embodiments, the one or more inserts 1030 may be inserted into the one or more recesses 1025 when the key connector 1001 is moved close to or attached to the key holder 1010. In embodiments, the positions of the recesses 1025 and the inserts 1030 may be reversed (e.g., inserts may be located in key holder 1000 and recesses may be located in key connector). In embodiments, the inserts and/or recesses may also be located at different positions on the front side of the key holder 1000 and the key connector 1001. FIG. 10B illustrates a key holder being connected or attached to a key connector may a key holder 1000 having tabs or inserts 1006 and a key connector 1001 having recesses 1007. In embodiments, the key holder 1000 could have recesses and the key connector 1001 could have inserts. In embodiments, one or more tabs or inserts 1006 of the key holder 1000 may be inserted into recesses 1007 within the key connector 1001 in order to connect the key holder to the key connector 1001.

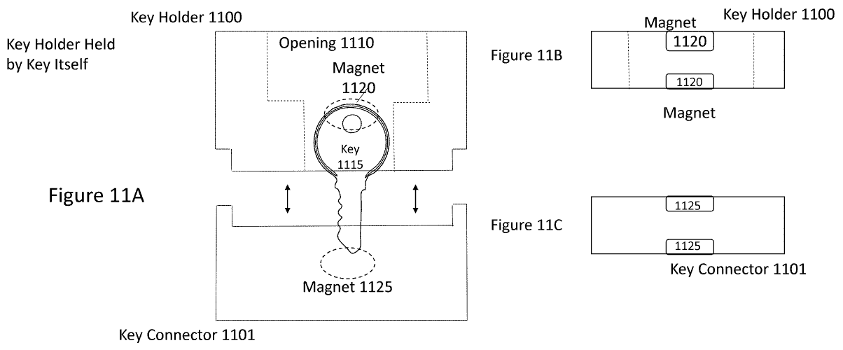

FIG. 11A illustrates a key itself (especially if metallic) being utilized to connect a key holder and key connector according to embodiments. FIG. 11B illustrates a front view of a key holder according to embodiments. FIG. 11C illustrates a front view of a key connector according to embodiments. In embodiments, a key holder 1100 may comprise one or more magnets 1120 being installed on an interior surface of a key holder 1100 (e.g., an interior top surface and/or an interior bottom surface). In embodiments, the one or more magnets 1120 may attach or connect to the key 1115 when the key is inserted into the key holder 1100. In embodiments, a key connector 1101 may include one or more magnets 1125 connected to an interior surface (e.g., bottom or top surface) of a key connector 1101. In embodiments, when the key holder 1100 is connected or attached to the key connector 1101, the key 1115 may also attach to the one or more magnets 1125 in the key connector 1101. In this manner, the key 1115 may be attached to one or more magnets 1120 in the key holder 1100 and one or more magnets 1125 in the key connector 1101, which makes it a stronger connection and/or attachment.

In embodiments, the benefit of a key attachment described herein the key attachment is compact and easy to store. In embodiments, the key attachment has a comfortable hand grip. In embodiments, a key attachment provide more room to label. In embodiments, because a key attachment is comprised of a key holder and a key connector, it may be labeled on both sides and thus it is easier to find and/or navigate the location. The key attachment design and specifically the key holder design makes it easier to install a key into the unit. As will be described herein, one or more key attachments may be placed onto a key sheet or similar device and thus the one or more key attachments may be stored in a filing cabinet, an auto sun visor, a ring binder, a clip folder and/or a lock box (key box or valet key box). In embodiments, the key attachments could be put in a fabric holder and the fabric holder could be attached and/or wrapped around the sun visor. Additionally, the key attachment (or one of the key holder or the key connector) could have a Velcro piece attached that would attach to the material or cloth of the sun visor.

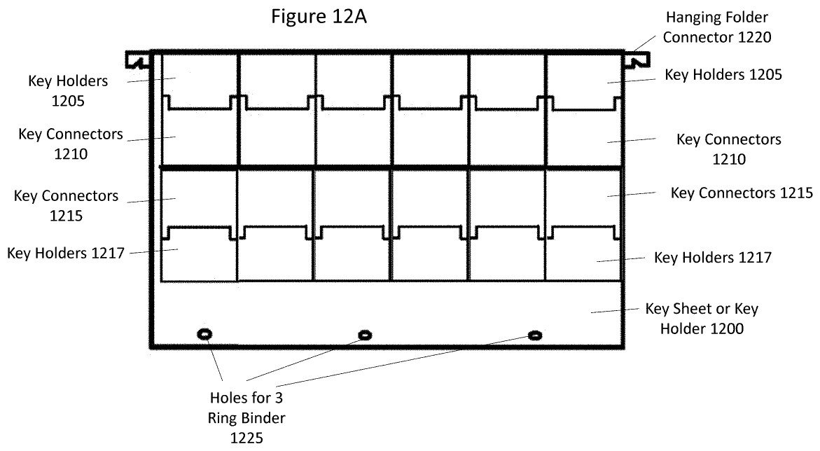

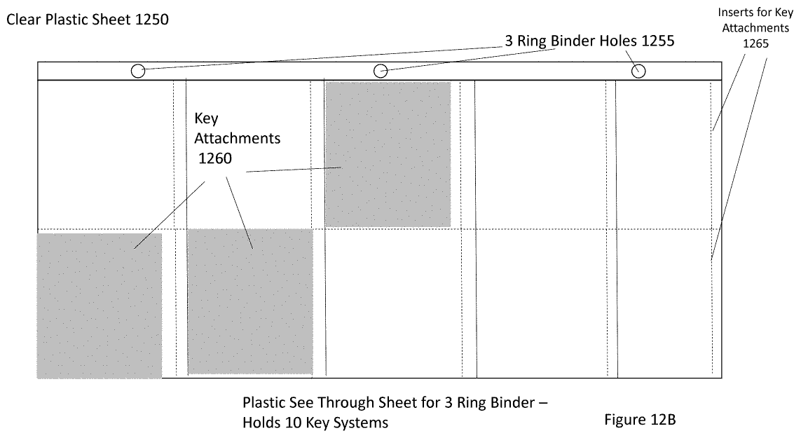

Accordingly to another novel aspect, in embodiments, a sheet may include a plurality of key attachments. FIG. 12A illustrates a key sheet having a plurality of key attachments according to embodiments. In embodiments, a key sheet 1200 may be a paper sheet, a plastic sheet, a cardboard sheet or a metal sheet or sheet made of one or more of the above-mentioned materials. In embodiments, a key sheet 1200 may have three holes 1225 in order to fit into a three ring binder. In embodiments, a sheet may part of a filing folder 1220 that is part of filing cabinet (e.g., like a hanging folder 1226 that is attached to rails of a drawer of a file cabinet). In embodiment, a sheet may have more than one hole and may be placed so that it vertically hangs in a key box. In embodiments, a key box is currently present in many valet parking lots. In some embodiments, a three ring binder clip may be present in a key box or maybe a couple of rings or holders may be placed on a side of a key box in order to let a sheet or multiple sheets to stay in place in the key box. In embodiments, a valet station may include one or more sheets hung vertically. In embodiments, a key sheet 1200 may be two sided, so that if 12 key attachments are present on one side of a key sheet 1200, 12 more key attachments may be present on a second side of key sheet 1200. In embodiments, more or less key attachments may be placed or be included on first side and/or a second side of a key sheet 1200. FIG. 12B illustrates a clear plastic sheet that holds a plurality of key attachments according to embodiments. In embodiments, a clear plastic sheet 1250 includes a plurality of key attachment inserts 1265 and in FIG. 12B, there are 10 inserts. In embodiments, FIG. 12B illustrates three key attachments 1260 inserted into key attachment inserts 1265, although 10 may be installed in the embodiment shown in FIG. 12B. In embodiments, there may be a second side of the clear plastic sheet which also holds a plurality of key attachments (e.g., key connectors attached to key holders). In embodiments, a clear plastic sheet 1250 may comprise three holes 1255 to allow insertion into a three-ring binder. Further, a clear plastic sheet may be integrated into a hanging folder to allow for installation into a file cabinet.

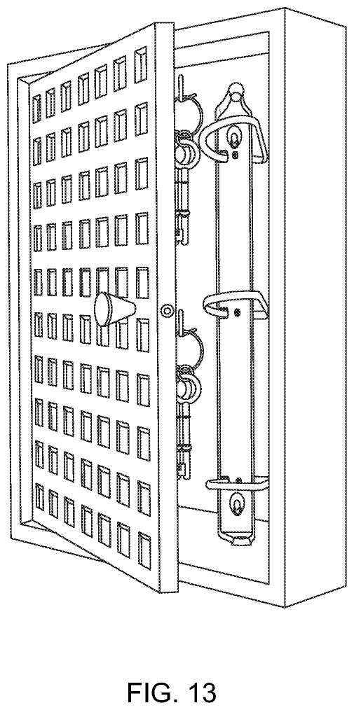

FIG. 13 attempts to illustrate three rings and a spine being inserted into a valet key box or key box. In this embodiments, one or more key sheets would be hung vertically by placing the holes 1225 onto the three rings. The key sheet design and possible hanging or binding solutions may provide many benefits. For example, the key sheet design (one or two sided, is compact) and may allow from between 12 and 24 keys to fit or be placed on one key sheet. As discussed before, the key sheet may be stored in a file cabinet with hanging folder and/or a ring binder folder. In embodiments, the key sheet design is easy to carry around in a notebook, for example. In embodiment, because of the ways the keys may be secured in the key holder and/or the key attachment, there are on key chain sound. Due to the labels, the key sheet is easy to navigate with a reduction in lost keys from prior art solutions. In embodiments, a large amount or number of keys may be utilized with the key attachment (e.g., key holder and key connector design). In embodiments, for example, over 90% of keys may utilize the key attachment described herein.

In some embodiments, a two-piece key attachment includes a key holder and a key connector. In some embodiments, the key holder includes a first edge opening on an insertion side; a second edge opening on a connection side; an interior opening, the interior opening formed by two or more interior walls; and one or more connectors, wherein the key holder is configured to have a key inserted through the first edge opening and have a portion of the key exiting the connection side. In some embodiments, the key connector includes a first edge opening on a connection side, the first edge opening configured to receive the portion of the key that exits the connection side of the key holder; and one or more opposing connectors to attach to the one or more connectors on the key holder. In some embodiments, the first edge opening of the key holder has a longer length dimension than a length dimension of the second edge opening. In some embodiments, the interior opening is divided into an insertion interior opening and a connection interior opening. In some embodiments, the area of the insertion interior opening is greater than an area connection interior opening and this allows a top of an inserted key to be position in the insertion interior opening and not to be able to inserted into the connection interior opening. In some embodiments, a first dimension of the insertion interior opening is greater than a first dimension of the connection interior opening and the first dimension of the connection interior opening is less than a width dimension of the key so that the key may press against at least one side of the key when the key is positioned in the connection interior opening.

In some embodiments, the key holder and the key connector may each further include a pull tab and the pull tabs may be utilized to separate the key holder from the key connector. In some embodiments, the key holder may also include a label, where the label is attached to a surface of the key holder and identifies which or whose key is I the two-piece key attachment. In some embodiments, the key holder may include a grip tab which is attached to a top surface of the key holder. The grip tab may have a height equal to the height of the key holder and may be configured to separate the key holder from the key connector. In some embodiments, the key holder may include another two or more interior walls, the another two or more interior walls defining a smaller interior space compared to the interior space formed by the two or more interior walls, wherein the smaller interior space prevents the key from moving once the key is inserted into the key holder.

In some embodiments, the key holder also includes a shim. In some embodiments, the shim may inserted into the interior opening. In some embodiments, the shim is positioned between the key and an interior top surface or an interior bottom surface to keep the key in place in the key holder. In some embodiments, the key holder may include a velcro strip. In some embodiments, the velcro strip may be positioned in the interior opening and may be attached to an interior top surface or an interior bottom surface of the key holder. In some embodiments, the velcro strip may attach to an opposing veclro strip that is located on the inserted key. In some embodiments, the key holder may include a pin opening on a side. In some embodiments, the side is adjacent to the first side. In some embodiments, the pin opening leads to a channel. In some embodiments, the pin is inserted into the channel to press against an inserted key to hold the key in the interior space of the key holder.

In some embodiments, the key holder includes a pin and one or more holes in a top surface of the key holder. In this embodiment, the pin is inserted into the one or more holes in the top surface and through a hole in the inserted key to hold the key in the interior space of the key holder. In this embodiment, the pin is pressed against the interior surface of a bottom or back of the key holder.

In some embodiments, the key holder further includes a hole and a screw, where the hole is in the top surface of the key holder. In this embodiment, the screw is inserted through the hole in the top surface and through a hole in the inserted key in order to press against an interior bottom surface of the key holder to hold the key in the key holder. In some embodiments, the two or more connectors of the key holder are channels and the two or more connectors of the key connector are grooves and the grooves are inserted into the channels to attach the key holder to the key connector. In some embodiments, the two or more connectors of the key holder are magnets and in some embodiments, the two or more opposing connectors are metallic pieces or assemblies. In some embodiments, the metallic pieces or assemblies may be attached to the magnets to attach the key holder to the key connector. In some embodiments, the two or more connectors of the key holder are clips and the two or more opposing connectors are recesses. In some embodiments, the recesses accept a portion of the one or more clips to attach the key holder to the key connector. In some embodiments, the two or more connectors of the key holder are inserts and the two or more opposing connectors are recesses to accept the inserts to attach the key holder to the key connector. In some embodiments, a plastic sheet with holes for inserting the sheet into a three-ring binder or a key storage box may have spaces for a plurality of key attachments to be inserted. The plastic sheet may have a channel running along an opposite side from the three holes. This may allow the plastic sheet to have a hanging folder connector inserted into the channel and also allow the plastic sheet to be hung in a device that holds handing folders (e.g., filing cabinets or portable filing folders).

The above disclosure is sufficient to enable one of ordinary skill in the art to practice the invention, and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A two-piece key attachment, comprising:
a key holder, the key holder comprising:
a first edge opening on an insertion side;
a second edge opening on a connection side;
an interior opening, the interior opening formed by two or more interior walls; and
one or more connectors, wherein the key holder is configured to have a key inserted through the first edge opening and have a portion of the key exiting the connection side; and
a key connector, the key connector comprising:
a first edge opening on a connection side, the first edge opening configured to receive the portion of the key that exits the connection side of the key holder; and
one or more opposing connectors to attach to the one or more connectors on the key holder.

2. The two-piece key attachment of claim 1, wherein the first edge opening of the key holder has a longer length dimension than a length dimension of the second edge opening.

3. The two-piece key attachment of claim 1, wherein the interior opening is divided into an insertion interior opening and a connection interior opening.

4. The two-piece key attachment of claim 3, wherein an area of the insertion interior opening is greater than an area of the connection interior opening to allow a top of the key to be positioned in the insertion interior opening and not to be able to be positioned in the connection interior opening.

5. The two-piece key attachment of claim 3, wherein a first dimension of the insertion interior opening is greater than a first dimension of the connection interior opening and the first dimension of the connection interior opening is less than a width dimension of the key in order to press against at least one side of the key as the key is positioned in the connection interior opening.

6. The two-piece key attachment of claim 1, the key holder further comprising a pull tab and the key connector further comprising another pull tab, the pull tab and the another pull tab utilized to separate the key holder from the key connector.

7. The two-piece key attachment of claim 1, the key holder further comprising a label, the label attached to a surface of the key holder and to provide an identifier of which key is in the two-piece key attachment.

8. The two-piece key attachment of claim 1, the key holder further comprising a grip tab attached to a top surface of the key holder and having a height approximately equal to the height of the key holder, the grip tab configured to separate the key holder from the key connector.

9. The two-piece key attachment of claim 1, the key holder further comprising another two or more interior walls, the another two or more interior walls defining a smaller interior space compared to the interior space formed by the two or more interior walls, wherein the smaller interior space prevents the key from moving once the key is inserted into the key holder.

10. The two-piece key attachment of claim 1, the key holder further comprising a shim, the shim inserted in the interior opening, the shim positioned between the key and an interior top surface or interior bottom surface of the key holder to hold the key in place in the key holder.

11. The two-piece key attachment of claim 1, the key holder further comprising a velcro strip, the velcro strip positioned in the interior opening and attached to an interior top surface or an interior bottom surface of the key holder, the velcro strip to attach to an opposing velcro strip that is located on an inserted key.

12. The two-piece key attachment of claim 1, the key holder further comprising a pin opening on a side adjacent to the first side, the opening leading to a channel, wherein a pin is inserted into the channel to press against an inserted key to hold the key in the interior space in the key holder.

13. The two-piece key attachment of claim 1, the key holder further comprising a pin and one or more holes in a top surface of the key holder, wherein the pin is inserted into the one or more holes in the top surface and through a hole in an inserted key to hold the key in the interior space of the key holder.

14. The two-piece key attachment of claim 14, wherein the pin is pressed against an interior surface of a bottom or back of the key holder.

15. The two-piece key attachment of claim 1, the key holder further comprising a screw and a hole, the hole in the top surface of the key holder, wherein the screw is inserted through the hole into the top surface and through a hole in an inserted key to press against an interior bottom surface of the key holder to hold the key in the key holder.

16. The two-piece key attachment of claim 1, wherein the two or more connectors of the key holder are channels and the two or more connectors of the key connector are grooves and the grooves are inserted into the channels to attach the key holder to the key connector.

17. The two-piece key attachment of claim 1, wherein the two or more connectors of the key holder are magnets and the two or more connectors of the key connector are metallic pieces, wherein the metallic pieces are attracted to the magnets to attach the key holder to the key connector.

18. The two-piece key attachment of claim 1, wherein the two or more connectors of the key holder are clips and the two or more connectors of the key connector are recesses to accept a portion of the two or more clips to attach the key holder to the key connector.

19. The two-piece key attachment of claim 1 wherein the two or more connectors of the key holders are inserts and the two or more connectors of the key connectors are recesses to accept the inserts to attach the key holder to the key connector.

20. A sheet for one or more key attachments, comprising:
a plastic material having two or more rows of holders configured to hold the one or more key attachments;
three holders on one side of the plastic material to be utilized to allow the plastic material to be placed in a three-ring binder; and
a channel running along an opposite side of the plastic material, the channel configured to have a hanging folder connector inserted into the channel and to allow the sheet to be hung in a device that holds hanging folders.
